(19) United States
(12) Patent Application Publication
(10) Pub. No.: US 2022/0270110 A1
(43) Pub. Date: Aug. 25, 2022

(54) MEMBERSHIP MANAGEMENT METHOD AND DEVICE THEREFOR

(71) Applicant: Coupang Corp., Seoul (KR)

(72) Inventors: Seung Hwan Lee, Seoul (KR); Moon Hee Kim, Seoul (KR); Catherine Chang, Seoul (KR); Kun Soo Han, Seoul (KR); Hyun A Park, Seoul (KR)

(21) Appl. No.: 17/191,553

(22) Filed: Mar. 3, 2021

(30) Foreign Application Priority Data
Feb. 22, 2021 (KR) 10-2021-0023251

(51) Int. Cl. G06Q 30/00

(52) U.S. Cl. CPC G06Q 30/016

(57) ABSTRACT

A member information management method in an electronic apparatus of the present disclosure includes obtaining a request to withdraw from a service from a user, identifying first information related to the user's account, identifying second information, based on the first information, including at least one of whether there is an ongoing order, whether there is a residual asset related to the service, and whether there is an outstanding amount after payment related to the service, and providing a withdrawal restriction response determined based on at least one of the second information in response to the withdrawal request when the second information does not satisfy a withdrawal condition.

### BACKGROUND

### Technical Field

The present disclosure relates to a member information management method and an apparatus therefor.

### Description of the Related Art

With the development of online commerce, users can use various online services for purchase. In addition, in order for users to use each online service, they must register as a member for each website that provides the service.

If the user no longer wants to use the website, the user can request membership withdrawal. However, if the request for withdrawal is immediately approved without reviewing the conditions of withdrawal for the account, damage to the service provider occurred when the user had not paid for the use of the service, or the account information was canceled due to withdrawal but additional processing was required for the user who had already withdrawn. In addition, when withdrawal is approved even though the user's cashable assets remain in the account, the account is canceled and recovery is difficult, so that the user suffers asset damage. Therefore, if the account does not meet the conditions for withdrawal and the membership withdrawal cannot be approved, the service provider needs to limit the withdrawal of the account.

As a prior document related to this, there is Korean Patent Registration No. 10-2013186.

### SUMMARY

### Technical Goals

An aspect of the present disclosure provides a member information management method and an apparatus therefor. The technical aspect to be achieved by the present disclosure is not limited to those described above, and other technical aspects may be inferred from the following example embodiments.

### Technical Solutions

According to an aspect, there is provided a member information management method in an electronic apparatus, the method including obtaining a request to withdraw from a service from a user, identifying first information related to the user's account, identifying second information, based on the first information, including at least one of whether there is an ongoing order, whether there is a residual asset related to the service, and whether there is an outstanding amount after payment related to the service, and providing a withdrawal restriction response determined based on at least one of the second information in response to the withdrawal request if the second information does not satisfy a withdrawal condition.

According to another aspect of the present disclosure, there is also provided a terminal for managing member information, the terminal including a communication device, an input device, an output device, and a processor operably coupled to the communication device, the input device, and the output device. The processor is configured to receive a request to withdraw from a service from a user via the input device, transmit the withdrawal request to an electronic apparatus via the communication device, receive a withdrawal restriction response in response to the withdrawal request from the electronic apparatus via the communication device, and output information on the withdrawal restriction response via the output device. The withdrawal restriction response is determined based on at least one of second information in response to the withdrawal request if the second information identified based on the first information related to the user's account does not satisfy a withdrawal condition. The second information includes at least one of whether there is an ongoing order, whether there is a residual asset related to the service, and whether there is an outstanding amount after payment related to the service.

According to yet another aspect of the present disclosure, there is also provided an electronic apparatus for managing member information, the electronic apparatus including a communication device, a storage device, and a controller for controlling the communication device and the storage device. The controller is configured to obtain a request to withdraw from a service from a user terminal via the communication device, identify first information related to the user's account via the storage device, identify second information, based on the first information, including at least one of whether there is an ongoing order, whether there is a residual asset related to the service, and whether there is an outstanding amount after payment related to the service, and provide the user terminal, via the communication device, with a withdrawal restriction response determined based on at least one of the second information in response to the withdrawal request if the second information does not satisfy a withdrawal condition.

Details of other example embodiments are included in the detailed description and drawings.

### Effects

According to the present disclosure, for the case of the user's account requesting membership withdrawal, if immediate approval of withdrawal may lead to damage to the service provider such as the case that there is an ongoing order or an outstanding amount after payment, etc., the withdrawal request can be withheld until the completion of the procedure, which may prevent damage to the service provider.

In addition, for the case of the user's account requesting membership withdrawal, if immediate approval of withdrawal may lead to loss of the user's asset such as the case that there are the user's cashable assets remaining, etc., the withdrawal request can be withheld until the user's consent or refund process, which may prevent damage to the user.

The effects of the present disclosure are not limited to the effects mentioned above, and other effects not mentioned will be clearly understood by those skilled in the art from the description of the claims.

### BRIEF DESCRIPTION OF THE DRAWINGS

FIG. 1 shows a system for managing member information according to an example embodiment.

FIGS. 2A and 2B are diagrams illustrating information on a withdrawal restriction response provided to a user according to an example embodiment.

FIG. 3 is a flowchart illustrating a member information management method in an electronic apparatus according to an example embodiment.

FIG. 4 is a block diagram illustrating a user terminal for a member information management method according to an example embodiment.

FIG. 5 is a block diagram illustrating an electronic apparatus for a member information management method according to an example embodiment.

### DETAILED DESCRIPTION

The terms used in the embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “includes” a certain component, it means that other components may be further included, and it does not preclude other components, unless otherwise stated. In addition, terms such as “ . . . unit”, “ . . . module” described in the specification mean a unit for performing at least one function or operation, which may be implemented as hardware or software, or as a combination of hardware and software.

Throughout the specification, expression “at least one of a, b, and c” may include ‘a only’, ‘b only’, ‘c only’, ‘a and b’, ‘a and c’, ‘b and c’, or ‘all of a, b, and c’.

The “terminal” mentioned below may be implemented as a computer or a mobile terminal that can access a server or other terminal through a network. Here, the computer includes, for example, a notebook, a desktop, a laptop, and the like, equipped with a web browser, and the mobile terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, or the like.

Embodiments of the present disclosure will be described in detail with reference to the accompanying drawings so that those skilled in the art may easily implement the present disclosure. However, the present disclosure may be implemented in various different forms and is not limited to the embodiments described herein. In the present disclosure, an item may mean a single item or a set of items of the same kind. Hereinafter, example embodiments of the present disclosure will be described in detail with reference to the drawings.

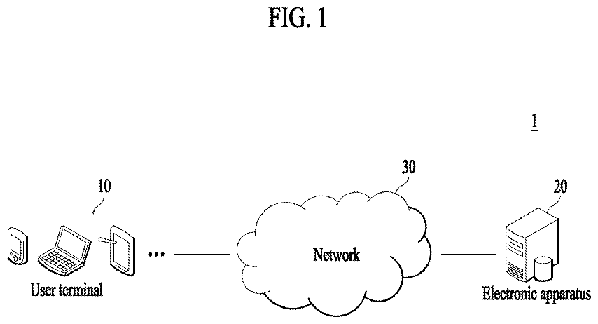

FIG. 1 shows a system for managing member information according to an example embodiment.

Referring to FIG. 1, the system 1 for managing member information may include a user terminal 10 and an electronic apparatus 20. In the system 1 for managing member information shown in FIG. 1, only components related to the present example embodiment are shown. Therefore, those skilled in the art to which the present disclosure pertains would appreciate that other general-purpose components may be further included in addition to the components illustrated in FIG. 1.

The user terminal 10 and the electronic apparatus 20 may communicate with each other through a network 30. The network 30 includes a local area network (LAN), a wide area network (WAN), a value added network (VAN), a mobile radio communication network, a satellite communication network, and a combination thereof. It is a data communication network in a comprehensive meaning that enables each network member shown in FIG. 1 to communicate with each other smoothly, and may include a wired Internet, a wireless Internet, and a mobile wireless communication network. Wireless communication may be, for example, wireless LAN (Wi-Fi), Bluetooth, Bluetooth low energy, Zigbee, WFD (Wi-Fi Direct), UWB (ultra wideband), infrared communication (IrDA, infrared Data Association), NFC (Near Field Communication), and the like, but it is not limited thereto.

The user terminal 10 may provide information related to a service that a user is using by registering as a member. The user may subscribe to a service operated by the electronic apparatus 20 through the user terminal 10, and may input a request for withdrawal of a member if the user wishes to withdraw. The user terminal 10 may receive a service subscription request or a service withdrawal request from the user and transmit the received request to the electronic apparatus 20. For example, the user terminal 10 may receive personal information for membership registration from the user, transmit the information to the electronic apparatus 20, and receive membership approval or rejection information from the electronic apparatus 20. Alternatively, the user terminal 10 may receive a request for member withdrawal from the user, transmit the request to the electronic apparatus 20, and receive a withdrawal approval or withdrawal restriction response from the electronic apparatus 20. For example, the request for membership registration or withdrawal may be made by selecting an interface element output on the user terminal 10.

According to an example embodiment, in response to the user's withdrawal request, if the user's account information does not satisfy with the withdrawal condition, the user terminal 10 may receive a response indicating that withdrawal is restricted from the electronic apparatus 20. In this case, the user terminal 10 may provide the user with information about which information among the information confirmed for the user's account does not satisfy the withdrawal condition. For example, information about factors that restrict withdrawal, such as whether there are any ongoing orders in the user account, whether there are residual assets of the user related to the service, and whether there are outstanding amounts after payment related to the service can be received from the electronic apparatus 20 and provided to the user. In addition, the user terminal 10 may provide information that does not satisfy with the withdrawal condition in detail for each withdrawal condition. Through this, the user can check what conditions must be satisfied in order to withdraw from the account through the user terminal 10.

According to an example embodiment, the user terminal 10 may request a processing input for satisfying the withdrawal condition in order to proceed with the account withdrawal. Specifically, in the case where the withdrawal restriction response provided by the user terminal 10 is provided based on the case that there is a residual asset related to the service in the user account, the user terminal 10 may provide a message requesting consent to lapse of the residual asset or an input request message for means for receiving the residual asset. Upon receiving consent to lapse of the residual asset from the user, the user terminal 10 may request the electronic apparatus 20 to approve the withdrawal request together with the user's consent information. On the other hand, if an input indicating rejection of lapse of the residual asset is received from the user, the user terminal 10 may provide information for inducing the use of the residual asset. A detailed description of this will be provided with reference to the following drawings. The user terminal 10 may request refund information on the residual asset. In addition, when refund information is received from the user, the information may be transferred to the electronic apparatus 20 to proceed with a refund procedure for transferring the residual asset. Such an example embodiment may be applied differently depending on whether the residual asset is a virtual asset paid based on a user's service usage details or a cash asset paid based on a user's payment. Meanwhile, in an example embodiment, the residual asset may include point information for purchasing items in connection with service use.

Meanwhile, when receiving a processing input for the withdrawal restriction response provided by the user terminal 10, it may be transmitted to the electronic apparatus 20, and the electronic apparatus 20 may determine whether or not to approve the withdrawal from the user account based on the received processing input again. When the user's account satisfies all of the withdrawal conditions according to the processing input, the electronic apparatus 20 may transmit a withdrawal approval response to the user terminal 10, and the user terminal 10 may provide withdrawal completion information. If not, the electronic apparatus 20 may transmit the withdrawal restriction response to the user terminal 10, and the user terminal 10 may request additional processing by the user by providing the information on the withdrawal restriction response again.

The electronic apparatus 20 of the system 1 for managing member information may receive a request for withdrawal from the service of the user from the user terminal 10 and determine whether the user's account can be withdrawn. To this end, the electronic apparatus 20 may identify first information related to the user's account. For example, the first information may correspond to member information stored in the server, and it may include information entered upon registering as a member and information stored in the server according to the service use such as ID, personal information (name, social security number, phone number, address, etc.), order details, payment information, service use history, etc. In addition, the electronic apparatus 20 may identify the second information based on the first information in order to determine whether the user's account can be withdrawn. Specifically, the second information may include information indicating whether there is an ongoing order in the user account, whether there are residual assets related to the service, and whether there is an outstanding amount after payment related to the service. According to an example embodiment, the electronic apparatus 20 may determine whether the user's account can be withdrawn by comparing the second information with the withdrawal condition. A detailed description of this will be provided with reference to the following drawings. Meanwhile, in an example embodiment, the electronic apparatus 20 may identify information related to the user account based on user identification information. The user identification information may include user ID information or information corresponding thereto, and the information related to the user account is user management information that corresponds to the user and can be mapped to the user identification information, which may include information except for the ID among the first information and at least some of the second information.

The electronic apparatus 20 of the present disclosure may be an apparatus included in a server for managing member information. The server for managing member information may update the server according to changes in user account information such as membership registration, dormancy, or withdrawal for a service (or platform) provided by the server.

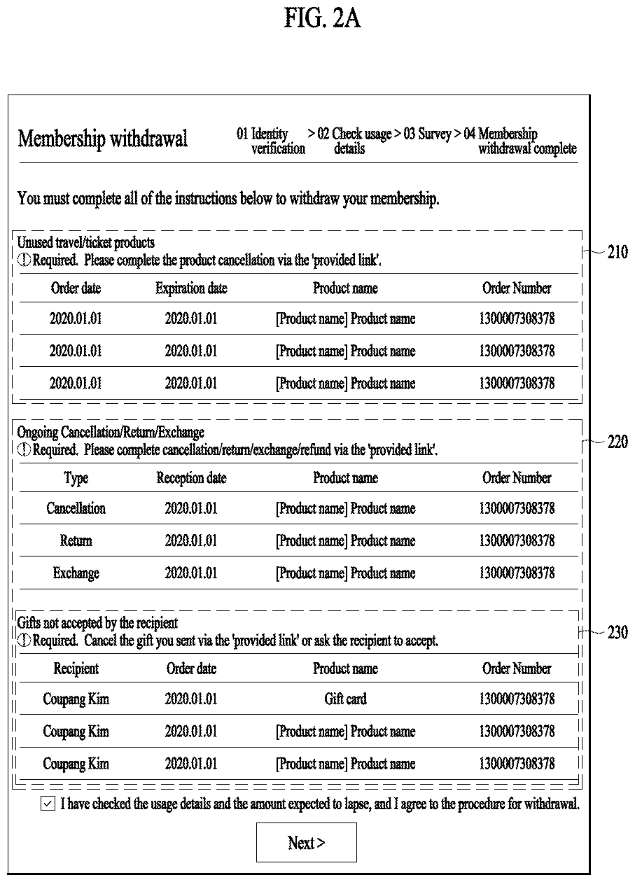

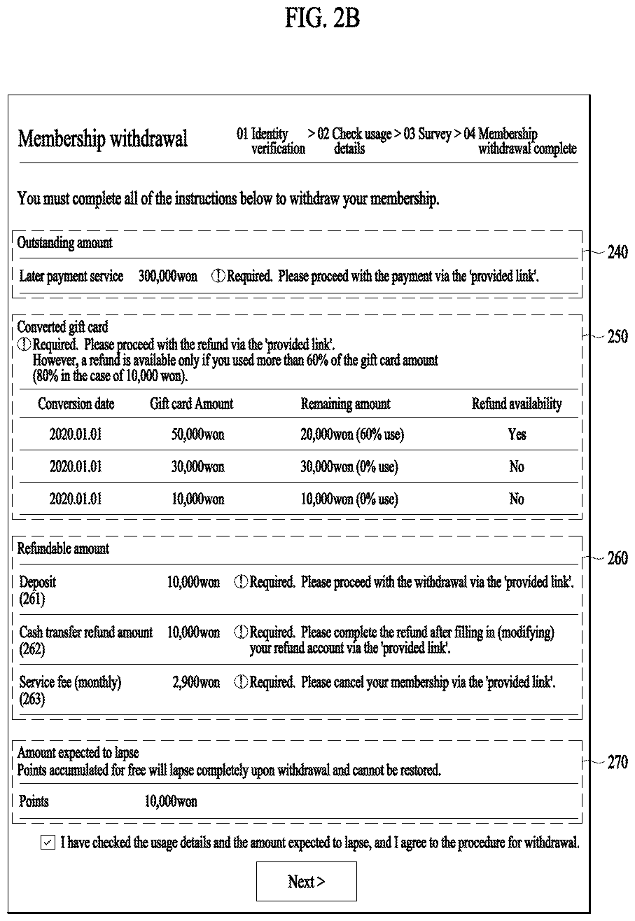

FIGS. 2A and 2B are diagrams illustrating information on a withdrawal restriction response according to an example embodiment. Throughout example embodiments, the information on the withdrawal restriction response may include information provided through the withdrawal restriction response.

According to an example embodiment, the electronic apparatus 20 may identify second information based on first information related to an account of a user who has requested withdrawal and determine whether the second information satisfies the withdrawal condition. As a result of the determination, when the second information does not satisfy the withdrawal condition, the withdrawal restriction response determined based on at least one of the second information may be provided to the user terminal 10. In addition, the user terminal 10 may request an additional procedure from the user by outputting information on the withdrawal restriction response. For example, the information on the withdrawal restriction response includes detailed information for each withdrawal condition that the second information is not satisfied with, and, more specifically, it may contain information about delivery information for an ongoing order, amount information for residual assets, and information about outstanding amounts.

FIG. 2A is a diagram for an example embodiment of providing information related to an order among information on a withdrawal restriction response. Specifically, FIG. 2A provides delivery information for an ongoing order, and as an example, the information provided may include information on an order 210 about an item that has not been used after payment or an order 220 that has been paid but before the purchase confirmation. The order 220 after payment and before purchase confirmation may include an order in which the item is on delivery, an order before collection after an order cancellation request, an order before collection after a return request, and an order before purchase confirmation after an exchange request. Alternatively, the order 220 after payment and before purchase confirmation may include an order 230 for another user. Items that have not been used after payment may include items for which the available time has not yet arrived. Items for which the available time has not yet arrived mean products for which the time when the product can be used is designated, such as travel, concerts, exhibitions, and lodging vouchers, etc. In this case, if the user withdraws before using the purchased item, the user cannot request a refund even before the available time, or the user cannot get a refund even if the item becomes unavailable. Accordingly, restrictions are required for withdrawal, and the process for withdrawal can proceed after the related product transaction is completed.

Referring to FIG. 2A, the electronic apparatus 20 may also provide detailed information for each order while listing information 210 on items that have not been used after payment. In the case of an item that has not been used after payment, it may be a digital product that is not for delivery, a product corresponding to a gift certificate that can be used to purchase other products, or a product corresponding to a ticket for which the available time is set.

In an example embodiment, the detailed information may include at least one of an order date, an expiration date for use, a product name, and an order number. The user can see which order among the purchased items must be processed in order for the user to withdraw through the detailed information. For example, the user may query the order details and cancel the corresponding order.

In addition, the electronic apparatus 20 may also provide detailed information for each order for the order 220 after payment and before purchase confirmation. For example, status information of an order such as on delivery, cancellation, return or exchange, a date when a request for an order is received, a product name, an order number, etc. may be provided as detailed information. In order to proceed with withdrawal, the user can inquire the details of an ongoing cancellation, return, or exchange request, and then the user may cancel the request, or hold the withdrawal until the request is completed. Alternatively, the electronic apparatus 20 may provide a request for withdrawal confirmation together with a purchase confirmation request to the user when it is determined that the item that is being ordered has been delivered.

If the counterpart receiving the purchased item is not the user himself/herself, the electronic apparatus 20 may hold the withdrawal of the purchaser until the recipient receives the item. To this end, the electronic apparatus 20 may provide detailed information for each order even for an order 230 which is for another user. For example, the recipient, order date, product name, order number, etc. may be provided together as detailed information. In order to proceed with withdrawal, the user may request cancellation of an order for which payment has been completed. The item subject to such an order with a third party as a recipient may be a tangible product but may also be an intangible product such as a mobile gift voucher, an online voucher, or a virtual cash asset, etc. In the case of an order for an intangible product, the user may instruct to ask the counterpart to receive the item via the user terminal 10. More specifically, the user may provide, via the user terminal 10, a message requesting the counterpart to receive an intangible digital product via the counterpart's terminal to the counterpart's terminal.

Also, according to an example embodiment, the electronic apparatus 20 may provide a link to a page through which additional information can be input to satisfy the withdrawal condition to the user. For example, when there is an unused item 210 after payment, a link for canceling the order for the item may be provided. Similarly, the electronic apparatus 20 may provide a link for inquiring details such as an ongoing delivery, cancellation, return, or exchange request for the order 220 after payment and before purchase confirmation and a link for canceling the order or requesting the counterpart to receive for the order 230 for another user.

Meanwhile, the order in which information on the withdrawal restriction response is listed is not limited to that shown in FIG. 2A, and the order in which the information is listed may be determined based on the order in which information related to the withdrawal restriction response is generated. In addition, although the process of FIG. 2A is described as being performed by the electronic apparatus 20, information may be provided via the user terminal 10 or the process may be performed by the user terminal 10.

FIG. 2B is a diagram of an example embodiment of providing information 240 on an outstanding amount and amount information 250, 260, and 270 on residual assets among information on a withdrawal restriction response. Referring to FIG. 2B, when there is an outstanding amount after payment related to a service, the electronic apparatus 20 may provide information for inducing payment for the amount. For example, a service related to a deferred payment in use and an outstanding amount may be provided as detailed information. According to an example embodiment, the electronic apparatus 20 may automatically terminate a deferred payment service associated with a user account and provide a link for payment for an order using a deferred payment in order to request payment to the user.

In addition, the electronic apparatus 20 may provide amount information 250, 260, and 270 on the residual assets, and the residual assets refer to remaining assets that have not been consumed among cashable assets accumulated or converted online. The residual assets may include information on the amount of assets 250 converted by purchasing a gift certificate, information on the amount of assets 261 charged by paying cash, information on the amount of assets 262 refunded according to the refund procedure of the order, information on the amount of assets 270 accumulated according to service use, and information on the amount of assets 263 that can be returned when a periodic payment for service use is terminated due to withdrawal.

According to an example embodiment, the electronic apparatus 20 may provide information on a date converted online, the amount of the gift certificate, the remaining amount after the amount of the gift certificate is converted and partially used, and information on whether a refund is available for the assets 250 converted by purchasing a gift certificate. Regarding availability of a refund, the electronic apparatus 20 may determine that a refund is available for the remaining amount when the user used more than a preset rate of the amount of the gift certificate. For example, if a gift certificate worth 30,000 won and it has not been used at all, a refund will not be available. On the other hand, if the preset minimum usage rate for refund is 60% and a portion of 30,000 won has been used for a gift certificate worth 50,000 won, the user can request a refund for the remaining amount of 20,000 won. This minimum usage rate may be set differently depending on the amount of the gift certificate.

The electronic apparatus 20 may provide information on the remaining amount and may further provide the user with a link for withdrawing the corresponding amount for the assets 261 charged by cash transfer. In addition, the electronic apparatus 20 may provide information on the remaining amount and may request refund information on the residual asset to the user for the assets 262 refunded according to the refund procedure of the order. For example, the electronic apparatus 20 may obtain refund account information to perform a refund procedure for the residual asset, and it may proceed with withdrawal of the user account after the refund is completed. In addition, the electronic apparatus 20 may calculate an asset 263 that can be returned when a periodic payment for service use is terminated due to user's withdrawal, and provide amount information. In this case, the electronic apparatus 20 may provide the user with a link for canceling the use of the corresponding service.

In addition, the electronic apparatus 20 may provide remaining amount information on the assets 270 accumulated according to the service use. The asset 270 accumulated according to the service use may not be an asset invested by the user himself/herself, but it may be an online asset accumulated for free from the server according to the user's order history. According to an example embodiment, the electronic apparatus 20 may request a user's consent to lapse the accumulated assets. When the electronic apparatus 20 obtains a consent input to the lapse of the accumulated assets from the user, it may proceed with withdrawal of the user account based on the response. In this case, the accumulated assets of the withdrawing user are removed from the server and cannot be restored.

According to an example embodiment, the electronic apparatus 20 may provide information for withdrawing from a member related to the service in order to cancel membership in which a user subscribes by regularly paying an amount to use a specific service. For example, a user who uses a membership can use a free shipping service, a service that provides delivery at a specific time (early morning or late night), etc. for his or her order by pre-paying a specified amount monthly or annually. Since the use of these services should be stopped when the user requests withdrawal from the service, payment for the fee for using the membership should also be stopped. In addition, since the user cannot use the specific service for the amount of time previously paid, the service provider needs to return the corresponding amount to the user. Accordingly, when the periodic payment for service use is canceled due to withdrawal, the electronic apparatus 20 may return the previously paid service usage fee to the user. To this end, the electronic apparatus 20 may provide a link for canceling the use of the service to the user.

Meanwhile, the order in which information on the withdrawal restriction response is listed is not limited to that shown in FIG. 2B. In addition, although the process of FIG. 2B is described as being performed by the electronic apparatus 20, information may be provided via the user terminal 10 or the process may be performed by the user terminal 10.

On the other hand, if the user does not agree to at least one of refund, withdrawal, or lapse of the residual assets, or refuses to cancel the service use, the electronic apparatus 20 may provide the user with information that can induce the use of the accumulated assets.

Specifically, the electronic apparatus 20 may calculate the total sum of residual assets and provide a message for recommending an item corresponding to the amount of the total residual assets to the user. In addition, when the user makes a purchase by checking the recommended item through the message or searching for another item and makes a payment using the residual assets, it is possible to check whether the purchase has been made as much as the total residual assets. If the purchase is made for the total residual assets, there will be no residual assets, and the withdrawal can be approved if the remaining withdrawal conditions are satisfied. At this time, when a purchase is made using such residual assets and a purchase is confirmed for the purchased product, information indicating that the withdrawal condition has been satisfied may be provided to the user. For example, when there are no more residual assets, there are no orders in progress, and there are no outstanding amounts, the electronic apparatus 20 may proceed with withdrawal of the account.

In addition, when the user purchases the item recommended by the electronic apparatus 20, a benefit according to the purchase may be provided to the user. According to an example embodiment, the electronic apparatus 20 may provide information for free use of a specific service to the user who has exhausted residual assets through purchase. For example, the electronic apparatus 20 may provide the user who has completed a purchase in a purchase window induced in order to use up the residual assets with information proposing promotions related to a free shipping service, a service that provides delivery at a specific time (early morning or late night), etc. as the membership service described above. In addition, a message indicating that the service can be provided free of charge for a certain period (e.g., one month) may be provided together.

Meanwhile, when the withdrawal procedure of the user account is completed, the electronic apparatus 20 may provide the user with information according to the user's service history based on member information related to the user account. For example, information about the user's service use period, the total number of purchases, the total amount of payment, and the amount of residual assets returned to the user may be provided to the user together with a notification of withdrawal approval.

According to an example embodiment, when the withdrawal procedure of the user account is completed, the electronic apparatus 20 may move and store member information of the user who has withdrawn into a database different from a previously stored database. At this time, only part of the member information is moved, and the remaining member information may be permanently deleted. Part of the member information that is moved and stored may be information necessary for the user to sign up for a member again in the future or to induce the user to sign up for a member again. For example, an email address and service usage record associated with the user account are moved and stored, and other information may be deleted according to laws and regulations. According to an example embodiment, the part of the moved and stored member information may be automatically deleted from the database after a preset period. For example, information stored separately after membership withdrawal may be permanently deleted automatically one year after being stored. At this time, the deletion of the information may be notified to the user who has withdrawn along with the deletion of the information.

Hereinafter, an operation method for managing member information will be described in detail through a flowchart according to an example embodiment of the present disclosure.

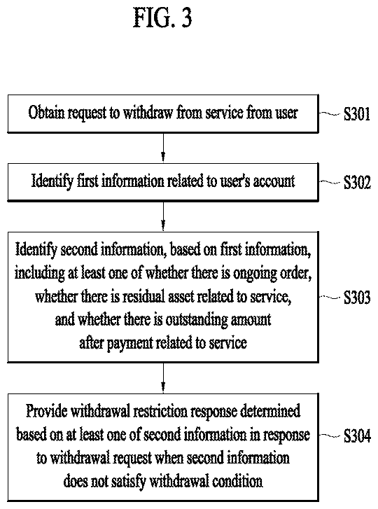

FIG. 3 is a flowchart illustrating a member information management method in an electronic apparatus according to an example embodiment. The electronic apparatus may be the electronic apparatus 20 of the member information management system 1.

In operation S301, the electronic apparatus 20 may obtain a request to withdraw from the service from a user. According to an example embodiment, the withdrawal request may be input by the user via the user terminal 10. For example, the user may request withdrawal by selecting a user interface element such as a withdrawal button output on the user terminal 10.

In operation S302, the electronic apparatus 20 may identify the first information related to the account of the user who has requested withdrawal. The first information may be stored in the first database and may correspond to member information.

In operation S303, the electronic apparatus 20 may identify the second information based on the first information, and the second information may include at least one of information indicating whether there is an ongoing order, whether there are residual assets related to the service, and whether there is an outstanding amount after payment related to the service. According to an example embodiment, the ongoing order may include an order that has been paid but before the purchase confirmation or an order about an item that has not been used after payment. In addition, the order after payment and before purchase confirmation may include an order in which the item is on delivery, an order before collection after an order cancellation request, an order before collection after a return request, and an order before purchase confirmation after an exchange request. Items that have not been used after payment may include items for which the available time has not yet arrived.

In operation S304, when the second information does not satisfy the withdrawal condition, the electronic apparatus 20 may provide the user terminal 10 with a withdrawal restriction response determined based on at least one of the second information in response to the withdrawal request. In addition, the electronic apparatus 20 may provide detailed information for each withdrawal condition that the second information is not satisfied with. The detailed information may contain at least one of delivery information for an ongoing order, amount information for residual assets, and information about outstanding amounts.

Alternatively, when there is a residual asset related to the service according to the second information, the electronic apparatus 20 determines that the second information does not satisfy the withdrawal condition and may request the user to consent to lapse of the residual asset. Upon receiving a response to the request for consent to lapse from the user terminal 10, it is possible to proceed with withdrawal of the user account based on the response.

Alternatively, if there is a residual asset related to the service according to the second information, the electronic apparatus 20 determines that the second information does not satisfy the withdrawal condition and may request refund information on the residual asset to the user terminal 10. Upon receiving the refund information through the user terminal 10, the residual asset may be refunded based on the received refund information. For example, the electronic apparatus 20 may receive refund account information from the user and control the user's residual asset to be transferred to the refund account. In addition, after the refund of the residual asset is completed, the electronic apparatus 20 may proceed with withdrawal of the user account.

Meanwhile, when the withdrawal of the user account is completed, the electronic apparatus 20 may move and store part of the first information to the second database. The second database may include a storage space different from the first database in which the first information is stored. In addition, the remaining part of the first information that has not been moved to the second database may be permanently deleted from the first database. According to an example embodiment, part of the first information stored in the second database may include an email address associated with the user account and a service use record. In addition, in order to protect the user's personal information, the part of the first information stored in the second database may be automatically deleted after a preset period. According to an example embodiment, when the first information stored in the second database is deleted, the electronic apparatus 20 may transmit a message indicating that information related to the account has been deleted to the withdrawn user.

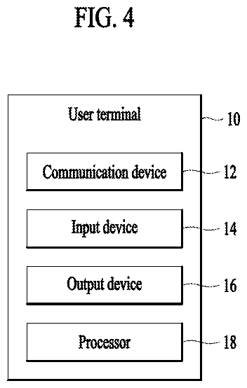

FIG. 4 is a block diagram illustrating a user terminal 10 for a member information management method according to an example embodiment.

According to an example embodiment, the user terminal 10 of the present disclosure may include a communication device 12, an input device 14, an output device 16, and a processor 18. The components shown in FIG. 4 are not essential in implementing the terminal, so those with ordinary skill in the art may understand that the terminal described in the present disclosure may have more or fewer components than the components listed above.

The communication device 12 may communicate with an external electronic apparatus using wired or wireless communication technology and may include a transceiver. The external electronic apparatus may be a terminal or a server. In addition, communication technologies used by the communication device 12 include Global System for Mobile communication (GSM), Code Division Multiple Access (CDMA), Long Term Evolution (LTE), 5G, Wireless LAN (WLAN), and Wi-Fi (Wireless-Fidelity), Bluetooth™ Radio Frequency Identification (RFID), Infrared Data Association (IrDA), ZigBee, Near Field Communication (NFC), and the like, but are not limited thereto.

According to an example embodiment, the communication device 12 may transmit a user's request to withdraw from the service to the electronic apparatus 20. In addition, the communication device 12 may receive a withdrawal restriction response from the electronic apparatus 20. In addition, the communication device 12 may transmit a user's processing input corresponding to the information on the withdrawal restriction response to the electronic apparatus 20. For example, consent to lapse the residual asset, refund information on the residual asset, and a request to cancel a service in use may be transmitted to the electronic apparatus 20 to determine whether or not the user account can be withdrawn again.

The input device 14 may include a camera or video input part for inputting an image signal, a microphone or audio input part for inputting an audio signal, and a user input part for receiving information from a user (for example, a touch key, a push key (mechanical key), etc.). In addition, the input device 14 may include one or more sensors for sensing at least one of information in the mobile terminal, information on surrounding environments around the mobile terminal, and user information. For example, the input device 14 may include at least one of a proximity sensor, an illumination sensor, a touch sensor, a motion sensor, a finger scan sensor, an optical sensor (for example, a camera), and a microphone. Meanwhile, the mobile terminal of the present disclosure may combine and utilize information sensed by at least two or more of these sensors.

According to an example embodiment, the input device 14 may receive a request for withdrawal from a service from a user. In addition, the user terminal 10 may receive consent to lapse the residual asset, refund information on the residual asset, and a request to cancel a service in use via the input device 14.

The output device 16 is for generating an output related to visual, auditory or tactile sense, and may include at least one of a display, an audio output part, a haptic module, and a light output part. The display can implement a touch screen by forming a layered or integrated structure with the touch sensor. Such a touch screen may function as a user input part that provides an input interface between the terminal and the user, and may provide an output interface between the terminal and the user. Thus, the input device 14 and the output device 16 may be included in the same device.

According to an example embodiment, the output device 16 may output information on the withdrawal restriction response. In addition, the output device 16 may output detailed information for each withdrawal condition that the second information is not satisfied with, and may output information requesting a user response thereto. For example, when the second information includes a residual asset related to a service, the output device 16 may output a message requesting consent to lapse the residual asset or request refund information for the residual asset.

The processor 16 may control the overall operation of the user terminal 10 and process data and signals. According to an example embodiment, the processor 16 may control operations of the communication device 12, the input device 14, and the output device 16 to manage information of a member who has requested withdrawal.

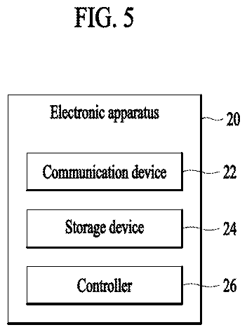

FIG. 5 is a block diagram illustrating an electronic apparatus 20 for a member information management method according to an example embodiment.

The electronic apparatus 20 of the present disclosure may include a communication device 22, a storage device 24, and a controller 26, according to an example embodiment. The components shown in FIG. 5 are not essential in implementing the electronic apparatus, so those with ordinary skill in the art may understand that the electronic apparatus described in the present disclosure may have more or fewer components than the components listed above.

The communication device 22 may communicate with an external electronic apparatus using wired or wireless communication technology as described above with respect to the communication device 12 of FIG. 4. According to an example embodiment, the communication device 22 may receive a service withdrawal request from the user terminal 10. In addition, the communication device 22 may provide a withdrawal restriction response determined based on at least one of the second information in response to the received withdrawal request. At this time, the second information may include at least one of whether there is an ongoing order, whether there are residual assets related to the service, and whether there is an outstanding amount after payment related to the service based on the first information in relation to the user's account.

The storage device 24 may store information related to a user. For example, the storage device 24 may store member information on a user who has subscribed to the service. According to an example embodiment, there may be a plurality of databases of the storage device 24. Accordingly, member information of a subscriber may be stored in the first database, and a part of member information of a withdrawn user may be stored in the second database.

The controller 26 may control the overall operation of the electronic apparatus 20 and may process data and signals. According to an example embodiment, the controller 26 may search the storage device 24 to identify first information related to an account of a user who has requested withdrawal, and may identify the second information based on the first information. At this time, the second information may include at least one of whether there is an ongoing order, whether there is a residual asset related to the service, and whether there is an outstanding amount after payment related to the service.

According to an example embodiment, the controller 26 may determine whether the second information satisfies the withdrawal condition. And, when the second information does not satisfy the withdrawal condition, a withdrawal restriction response determined based on at least one of the second information in response to the withdrawal request may be provided to the user terminal 10 via the communication device 22.

The apparatus according to the above-described example embodiments may include a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

1. A membership management method operable by an electronic apparatus, the method comprising:
controlling, by a processor of the electronic apparatus, a transceiver of the electronic apparatus to communicate with a user device of a user;
obtaining, from the user device via the transceiver, a request to withdraw a membership of the user from a service;
identifying, by the processor, first information related to an account of the user;
identifying, by the processor, second information related to the user based on the first information, the second information comprising at least one of: ongoing order information related to the service, residual asset information related to the service, or outstanding payment amount information related to the service;
in response to determining there is at least one residual asset related to the account of the user, determining, by the processor, a total amount of the at least one residual asset wherein the at least one residual asset comprises at least one virtual residual asset and at least one cash residual asset;
generating a graphical user interface with a list of recommended products for purchase using the at least one residual asset based at least in part on the total amount of the at least one residual asset; and
in response to determining that the second information does not satisfy a withdrawal condition, providing a withdrawal restriction response generated based on at least one of the second information in response to the withdrawal request, the withdrawal restriction response comprising the list of recommended products.

2. The membership management method of claim 1, wherein the ongoing order information comprises orders with payment information but without purchase confirmation information or orders associated with items that have not been used after payment.

3. The membership management method of claim 2, wherein the orders with payment information but without purchase confirmation information comprise:
an order in which an item is on delivery;
an order before collection after an order cancellation request;
an order before collection after a return request; or
an order before purchase confirmation after an exchange request,
wherein the item that has not been used after payment includes an item for which the available time has not yet arrived.

4. The membership management method of claim 1, wherein:
the providing of the withdrawal restriction response comprises providing detailed information for each withdrawal condition that the second information does not satisfy; and
the detailed information includes at least one of: delivery information associated with the ongoing order information, amount information for the at least one residual asset, or the outstanding payment amount information.

5. The membership management method of claim 1, further comprising:
generating a request for the user to consent to a lapse of the at least one residual asset; and
proceeding with withdrawal of the user's account based on a response to the request to consent to the lapse.

6. The membership management method of claim 1, further comprising:
generating a request for refund information on the at least one residual asset;
in response to receiving the refund information, proceeding with a refund of the at least one residual asset based on the refund information; and
after completing the refund of the at least one residual asset, proceeding with withdrawal of the user's account.

7. The membership management method of claim 1, wherein the first information stored in a first database is deleted in response to the second information satisfying the withdrawal condition, and wherein at least part of the first information is recorded in a second database different from the first database.

8. The membership management method of claim 7, wherein the at least part of the first information stored in the second database includes an email address and service usage record associated with the user's account, and wherein the part of the first information is automatically deleted from the second database after a preset period is elapsed.

9. (canceled)

10. A non-transitory computer-readable recording medium storing thereon computer-readable instructions that, when executed by a processor of an electronic apparatus, cause the processor to:
control a communication device to communicate with a user device of a user;
obtain, from the user device via the communication device, a request to withdraw a membership of the user from a service;
identify first information related to an account of the user;
identify second information related to the user based on the first information, the second information comprising at least one of: ongoing order information related to the service, residual asset information related to the service, or outstanding amount information related to the service;
in response to determining there is at least one residual asset related to the user's account, determine, by the processor, a total amount of the at least one residual asset wherein the at least one residual asset comprises at least one virtual residual asset and at least one cash residual asset;
generate a graphical user interface with a list of recommended products for purchase using the at least one residual asset based at least in part on the total amount of the at least one residual asset; and
in response to determining the second information does not satisfy a withdrawal condition, provide the user device, via the communication device, a withdrawal restriction response generated based on at least one of the second information in response to the withdrawal request, the withdrawal restriction response comprising the list of recommended products.

11. A terminal for managing membership, the terminal comprising:
a communication device;
an input device;
an output device; and
a processor operably coupled to the communication device, the input device, and the output device,
wherein the processor is configured to:
receive, via the input device, a request to withdraw a membership of a user from a service;
transmit the request to withdraw to an electronic apparatus via the communication device;
receive a withdrawal restriction response in response to the withdrawal request from the electronic apparatus via the communication device, wherein the withdrawal restriction response is displayed by the output device as a graphical user interface with a list of recommended products, wherein the list of recommended products is generated based at least in part on a total amount of at least one residual asset related to an account of the user, wherein the at least one residual asset comprises at least one virtual residual asset and at least one cash residual asset; and
display the withdrawal restriction response via the output device,
wherein the withdrawal restriction response is generated in response to determining that second information does not satisfy a withdrawal condition, wherein the second information is identified based on a first information related to the user's account; and
wherein the second information comprises at least one of: ongoing order information related to the service, residual asset information related to the service, or outstanding payment amount information related to the service.

12. The terminal of claim 11, wherein the processor is further configured to output, via the output device, detailed information for each withdrawal condition that the second information does not satisfy, and wherein the detailed information includes at least one of: delivery information associated with the ongoing order information, amount information for the at least one residual asset, or outstanding payment amount information.

13. The terminal of claim 11, wherein the processor is further configured to:
output a message requesting consent to a lapse of the at least one residual asset via the output device;
receive a response to the message consenting to the lapse of the at least one residual asset via the input device; and
in response to the response to the message, transmit a request for approval of the withdrawal request to the electronic apparatus via the communication device.

14. The terminal of claim 11, wherein the processor is further configured to:
request refund information on the at least one residual asset via the output device; and
in response to receiving the refund information via the input device, transmit the refund information to the electronic apparatus via the communication device.

15. An electronic apparatus for managing, the electronic apparatus comprising:
a communication device;
a storage device; and
a controller for controlling the communication device and the storage device,
wherein the controller is configured to:
control the communication device to communicate with a user device of a user;
obtain, from the user device via a transceiver, a request to withdraw a membership of the user from a service;
identify first information related to an account of the user;
identify second information related to the user based on the first information, the second information comprising at least one of: ongoing order information related to the service, residual asset information related to the service, or outstanding amount information related to the service;
in response to determining there is at least one residual asset related to the user's account, determine a total amount of the at least one residual asset, wherein the at least one residual asset comprises at least one virtual residual asset and at least one cash residual asset;
generate a graphical user interface with a list of recommended products for purchase using the at least one residual asset based at least in part on the total amount of the at least one residual asset; and
in response to determining the second information does not satisfy a withdrawal condition, provide via the communication device, a withdrawal restriction response generated based on at least one of the second information in response to the withdrawal request, the withdrawal restriction response comprising the list of recommended products.
